(19) United States
(12) Patent Application Publication
(10) Pub. No.: US 2026/0252210 A1
(43) Pub. Date: Aug. 27, 2026

(54) RANKING GRAPHIC ELEMENTS IN MESSAGING APPLICATIONS

(71) Applicant: WhatsApp, LLC, Menlo Park, CA (US)

(72) Inventors: Thomas Moreno, London (GB); Gautam Khanna, London (GB); Anastasia Mironova, London (GB); Thomas James Weightman, London (GB)

(73) Assignee: WhatsApp, LLC, Menlo Park, CA (US)

(21) Appl. No.: 19/549,499

(22) Filed: Feb. 25, 2026

Related U.S. Application Data
(60) Provisional application No. 63/763,141, filed on Feb. 25, 2025.

(51) Int. Cl. G06F 3/0482; H04L 51/10

(52) U.S. Cl. CPC G06F 3/0482; H04L 51/10

(57) ABSTRACT

As disclosed herein, a computer-implemented method for ranking graphic elements in a conversation thread is provided. The computer-implemented method may include providing, in a conversation thread of a messaging application, a display of a plurality of graphic elements for a user to select from and post in the conversation thread. The computer-implemented method may include determining, for a graphic element, a timestamp for each posting of the graphic element in the conversation thread. The computer-implemented method may include determining, for the graphic element, a frequency of postings of the graphic element in the conversation thread. The computer-implemented method may include determining a ranking of the graphic element based on the timestamp for each posting and the frequency of the postings. The computer-implemented method may include updating, based on the ranking, a position of the graphic element in the display. A system and a non-transitory computer-readable storage medium are also disclosed.

### CROSS-REFERENCE TO RELATED APPLICATION

This application claims the benefit of US Application No. 63/763,141, filed February 25, 2025, the entirety of which is hereby incorporated by reference.

### BACKGROUND

### Field

The present disclosure generally relates to messaging applications. More particularly, the present disclosure relates to arranging graphic elements in a conversation thread of a messaging application according to a ranking of the graphic elements.

### Related Art

Messaging applications have become a cornerstone of modern communication, enabling users to express themselves through various forms of media, including text, images, and videos. Among the most popular and expressive media are graphic elements, such as emojis, stickers, or Graphics Interchange Format (GIF) images (GIFs), that convey emotions, ideas, or responses in a visually engaging manner. In conversation threads, users may post a graphic element in response to specific events, moods, or topics, making the graphic element contextually relevant at the time of use.

### SUMMARY

The subject disclosure provides for systems and methods for ranking graphic elements in a conversation thread. According to certain aspects of the present disclosure, a computer-implemented method is provided. The computer-implemented method may include providing, in a conversation thread of a messaging application, a display of a plurality of graphic elements for a user to select from and post in the conversation thread. The computer-implemented method may include determining, for a graphic element of the plurality of graphic elements, a timestamp for each posting of the graphic element in the conversation thread. The computer-implemented method may include determining, for the graphic element of the plurality of graphic elements, a frequency of postings of the graphic element in the conversation thread. The computer-implemented method may include determining a ranking of the graphic element based on the timestamp for each posting and the frequency of the postings. The computer-implemented method may include updating, based on the ranking, a position of the graphic element in the display of the plurality of graphic elements.

According to another aspect of the present disclosure, a system is provided. The system may include one or more processors. The system may include a memory storing instructions that, when executed by the one or more processors, cause the system to perform operations. The operations may include providing, in a conversation thread of a messaging application, a display of a plurality of graphic elements for a user to select from and post in the conversation thread. The operations may include determining, for a graphic element of the plurality of graphic elements, a timestamp for each posting of the graphic element in the conversation thread. The operations may include determining, for the graphic element of the plurality of graphic elements, a frequency of postings of the graphic element in the conversation thread. The operations may include determining a ranking of the graphic element based on the timestamp for each posting and the frequency of the postings. The operations may include updating, based on the ranking, a position of the graphic element in the display of the plurality of graphic elements.

According to yet other aspects of the present disclosure, a non-transitory computer-readable storage medium storing instructions encoded thereon that, when executed by a processor, cause the processor to perform operations, is provided. The operations may include providing, in a conversation thread of a messaging application, a display of a plurality of graphic elements for a user to select from and post in the conversation thread. The operations may include determining, for a graphic element of the plurality of graphic elements, a timestamp for each posting of the graphic element in the conversation thread. The operations may include determining, for the graphic element of the plurality of graphic elements, a frequency of postings of the graphic element in the conversation thread. The operations may include determining a ranking of the graphic element based on the timestamp for each posting and the frequency of the postings. The operations may include updating, based on the ranking, a position of the graphic element in the display of the plurality of graphic elements.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example environment suitable for ranking graphic elements in a conversation thread, according to some embodiments;

FIG. 2 is a block diagram illustrating details of an example client device and an example server from the example environment of FIG. 1, according to some embodiments;

FIG. 3 includes an example view of an input area of a user interface of a conversation thread of a messaging application, according to some embodiments;

FIG. 4 includes an example process for ranking graphic elements in a conversation thread of a messaging application, according to some embodiments;

FIG. 5 is a flowchart illustrating operations in a method for ranking graphic elements in a conversation thread, according to some embodiments; and

FIG. 6 is a block diagram illustrating an exemplary computer system with which client devices, and the methods and processes in FIGS. 4 and 5 may be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive. Those skilled in the art may realize other elements that, although not specifically described herein, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### General Overview

Messaging applications have become a cornerstone of modern communication, enabling users to express themselves through various forms of media, including text, images, and videos. Among the most popular and expressive media are graphic elements, such as emojis, stickers, or Graphics Interchange Format (GIF) images (GIFs), that convey emotions, ideas, or responses in a visually engaging manner. In conversation threads, users may post a graphic element in response to specific events, moods, or topics, making the graphic element contextually relevant at the time of use.

Over time, conversation threads (or “chats”) may accumulate many graphic elements, and users may struggle to find and reuse the most relevant graphic elements as a conversation thread evolves. Existing methods used by messaging applications either display options for graphic elements in the order the graphic elements were posted by a user, without any prioritization, or offer graphic elements suggestions based on historical use by a user or based on global popularity across the messaging application. Such existing methods do not fully optimize a graphical element display for an ongoing conversation, leading to inefficiencies when users search for specific graphic elements within the context of a conversation thread.

One key challenge in managing a display of graphic element options within a conversation thread is determining which graphic elements are the most relevant to a given context, especially for ongoing or lengthy conversations. A user may wish to quickly retrieve a graphic element that the user has already posted in the conversation thread, particularly graphic elements that are contextually appropriate or have been sent frequently within that specific conversation thread. However, the existing methods are not tailored to prioritize graphic element options based on a recency and a popularity of the graphic elements within the current conversation thread, which may differ significantly from graphic elements used across multiple conversation threads of the user or across a messaging application.

As disclosed herein, novel systems and methods provide for ranking and displaying graphic element options in a conversation thread of a messaging application. A graphic element may be ranked and displayed according to a recency score, which may describe how recently a graphic element has been posted by a user in the conversation thread, and a popularity score, which may describe how often the graphic element has been posted by a user in the conversation thread. These scores may be evaluated within the context of the current conversation thread, allowing a user to quickly locate the most relevant graphic element based on both timeliness and frequency of use within that specific thread.

According to some embodiments, a recency score may track when a graphic element was last posted by at least one user of a conversation thread. The graphic element may be selected by a user from a plurality of graphic elements displayed in an input area (e.g., a message box) of a user interface for a conversation thread of a messaging application. A graphic element that was sent more recently may be considered more relevant to the current conversation context and may receive a higher recency score. For example, graphic elements used to respond to recent messages or to represent ongoing events in the conversation may receive higher recency scores. A popularity score may track how frequently a graphic element has been posted within the conversation thread. Graphic elements that are used multiple times by at least one user of the conversation thread may be considered more popular within the context of the conversation thread and may receive a higher popularity score. For example, a higher popularity score for a graphic element may reflect common sentiments expressed by a group of users. The recency score and the popularity score may be combined to determine a ranking of a graphic element. According to the ranking, a position of a graphic element in the input area may be updated such that the position is more prominent if the ranking is higher than the ranking of another element or such that the position is less prominent if the ranking is lower than another element.

### Example System Architecture

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments may be practiced without these specific details. In other instances, well known structures and devices are shown in block diagram form in order to facilitate a description thereof. The intention is to cover all modifications, equivalents, and alternatives consistent with the claimed subject matter.

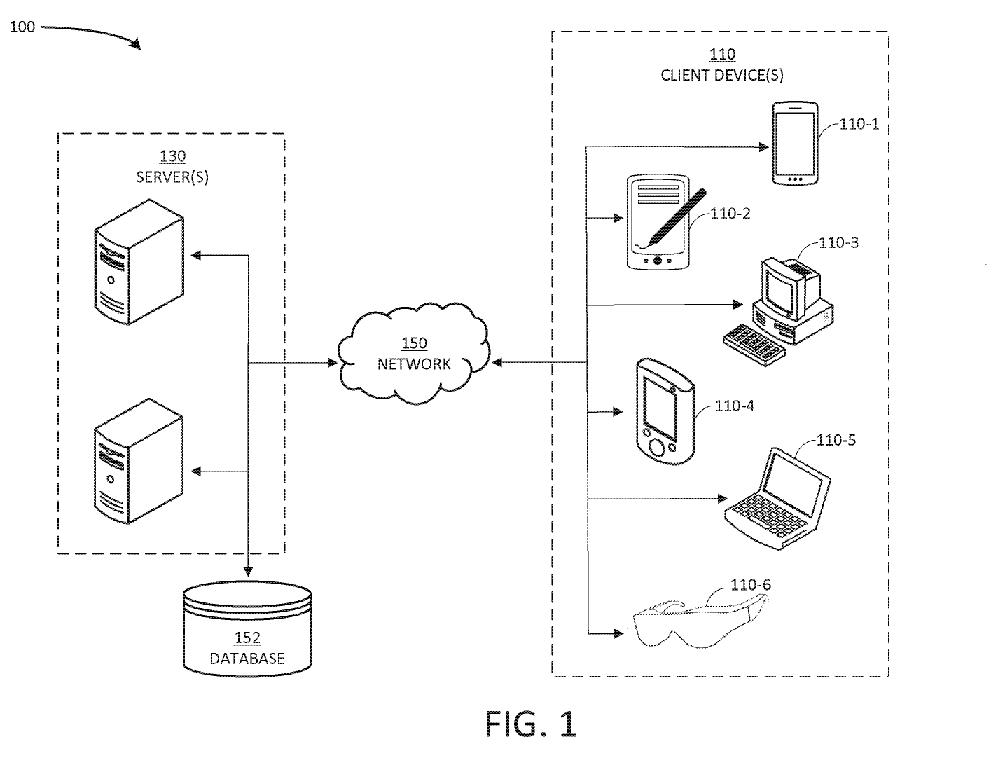

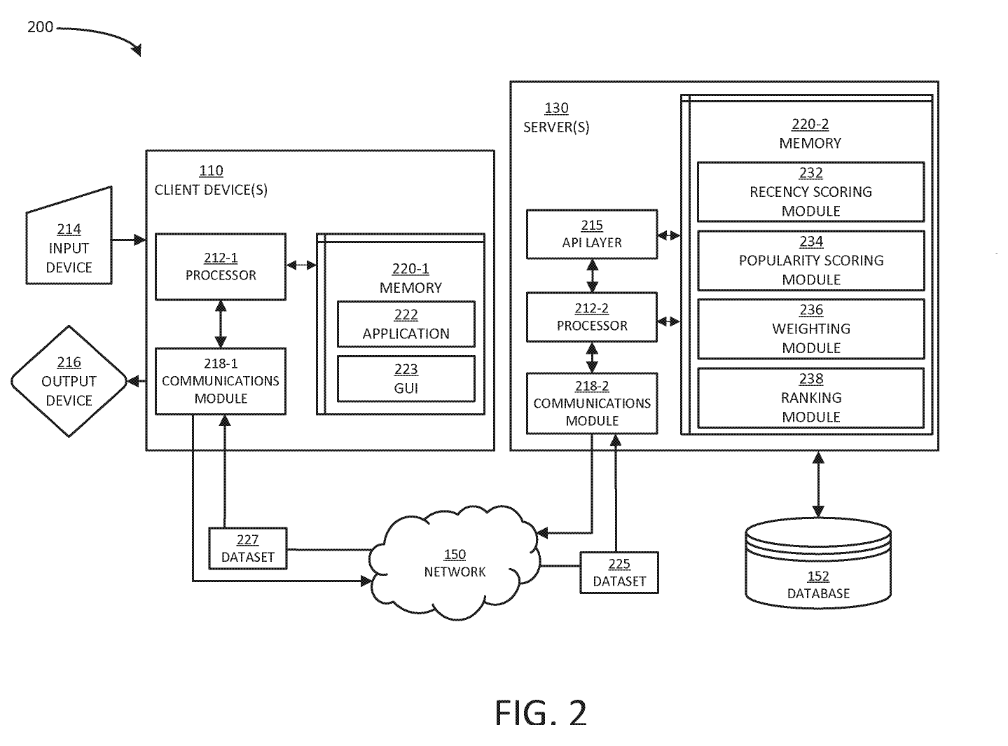

FIG. 1 illustrates an example environment 100 suitable for ranking graphic elements in a conversation thread, according to some embodiments. Environment 100 may include server(s) 130 communicatively coupled with client device(s) 110 and database 152 over network 150. One of server(s) 130 may be configured to host a memory including instructions which, when executed by a processor, cause server(s) 130 to perform at least some of the steps in methods as disclosed herein. In some embodiments, the processor may be configured to control a graphical user interface (GUI) for the user of one of client device(s) 110 accessing a recency scoring module (e.g., recency scoring module 232, FIG. 2), a popularity scoring module (e.g., popularity scoring module 234, FIG. 2), a weighting module (e.g., weighting module 236, FIG. 2), or a ranking module (e.g., ranking module 238, FIG. 2). Accordingly, the processor may include a dashboard tool, configured to display components and graphic results to the user via a GUI (e.g., GUI 223, FIG. 2). For purposes of load balancing, multiple servers of server(s) 130 may host memories including instructions to one or more processors, and multiple servers of server(s) 130 may host a history log or database 152 including multiple training archives for the recency scoring module, the popularity scoring module, the weighting module, or the ranking module. Moreover, in some embodiments, multiple users of client device(s) 110 may access the same recency scoring module, popularity scoring module, weighting module, or ranking module. In some embodiments, a single user with a single client device (e.g., one of client device(s) 110) may provide images and data (e.g., text) to train one or more artificial intelligence (AI) models running in parallel in one or more server(s) 130. Accordingly, client device(s) 110 and server(s) 130 may communicate with each other via network 150 and resources located therein, such as data in database 152.

Server(s) 130 may include any device having an appropriate processor, memory, and communications capability for the recency scoring module, the popularity scoring module, the weighting module, or the ranking module. Any of the recency scoring module, the popularity scoring module, the weighting module, or the ranking module may be accessible by client device(s) 110 over network 150.

Client device(s) 110 may include any one of a laptop computer 110-5, a desktop computer 110-3, or a mobile device, such as a smartphone 110-1, a palm device 110-4, or a tablet device 110-2. In some embodiments, client device(s) 110 may include a headset or other wearable device 110-6 (e.g., an mixed reality (XR) headset, smart glass, or head-mounted display (HMD), including a virtual reality (VR), augmented reality (AR), or extended reality (XR) headset, smart glass, or HMD), such that at least one participant may be running a mixed reality application—including a virtual reality application, an augmented reality application, or an extended reality application—installed therein.

Network 150 may include, for example, any one or more of a local area network (LAN), a wide area network (WAN), the Internet, and the like. Further, network 150 may include, but is not limited to, any one or more of the following network topologies, including a bus network, a star network, a ring network, a mesh network, a star-bus network, tree or hierarchical network, and the like.

A user may own or operate client device(s) 110 that may include a smartphone device 110-1 (e.g., an iPhone® device, an Android® device, a Blackberry® device, or any other mobile computing device conforming to a smartphone form). Smartphone device 110-1 may be a cellular device capable of connecting to a network 150 via a cell system using cellular signals. In some embodiments and in some cases, smartphone device 110-1 may additionally or alternatively use Wi-Fi or other networking technologies to connect to network 150. Smartphone device 110-1 may execute a client, Web browser, or other local application to access server(s) 130.

A user may own or operate client device(s) 110 that may include a tablet device 110-2 (e.g., an iPad® tablet device, an Android® tablet device, a Kindle Fire® tablet device, or any other mobile computing device conforming to a tablet form). Tablet device 110-2 may be a Wi-Fi device capable of connecting to a network 150 via a Wi-Fi access point using Wi-Fi signals. In some embodiments and in some cases, tablet device 110-2 may additionally or alternatively use cellular or other networking technologies to connect to network 150. Tablet device 110-2 may execute a client, Web browser, or other local application to access server(s) 130.

The user may own or operate client device(s) 110 that may include a laptop computer 110-5 (e.g., a Mac OS® device, Windows® device, Linux® device, or other computer device running another operating system). Laptop computer 110-5 may be an Ethernet device capable of connecting to a network 150 via an Ethernet connection. In some embodiments and in some cases, laptop computer 110-5 may additionally or alternatively use cellular, Wi-Fi, or other networking technologies to connect to network 150. Laptop computer 110-5 may execute a client, Web browser, or other local application to access server(s) 130.

FIG. 2 is a block diagram 200 illustrating example client device(s) 110 and example server(s) 130 from the environment of FIG. 1, according to some embodiments. Client device(s) 110 and server(s) 130 may be communicatively coupled over network 150 via respective communications modules 218-1 and 218-2 (hereinafter, collectively referred to as “communications modules 218”). Communications modules 218 may be configured to interface with network 150 to send and receive information, such as requests, responses, messages, and commands to other devices on the network in the form of datasets 225 and 227. Communications modules 218 may be, for example, modems or Ethernet cards, and may include radio hardware and software for wireless communications (e.g., via electromagnetic radiation, such as radiofrequency (RF), near field communications (NFC), Wi-Fi, or Bluetooth radio technology). Client device(s) 110 may be coupled with input device 214 and with output device 216. Input device 214 may include a keyboard, a mouse, a pointer, a touchscreen, a microphone, a joystick, a virtual joystick, and the like. In some embodiments, input device 214 may include cameras, microphones, and sensors, such as touch sensors, acoustic sensors, inertial motion units (IMUs), and other sensors configured to provide input data to an MR headset or head-mounted display (HMD) (including a VR, AR, or XR headset or HMD). For example, in some embodiments, input device 214 may include an eye-tracking device to detect the position of a pupil of a user in an MR headset or HMD. In some embodiments, input device 214 may include a head-tracking device to detect the position of a head of a user in an MR headset or HMD. Likewise, output device 216 may include a display and a speaker with which the user may retrieve results from client device(s) 110. Client device(s) 110 may also include processor 212-1, configured to execute instructions stored in memory 220-1, and to cause client device(s) 110 to perform at least some of the steps or operations in processes or methods consistent with the present disclosure. Memory 220-1 may further include application 222 and graphical user interface (GUI) 223, configured to run in client device(s) 110 and couple with input device 214 and output device 216. Application 222 may be downloaded by the user from server(s) 130 or may be hosted by server(s) 130. In some embodiments, client device(s) 110 may be an MR headset or HMD (including a VR, AR, or XR headset or HMD), and application 222 may be an MR application, such as a VR, AR, or XR application. In some embodiments, client device(s) 110 may be a mobile phone used to collect a video or picture and upload to server(s) 130 using a video or image collection application (e.g., application 222), to store in database 152. In some embodiments, application 222 may run on any operating system (OS) installed in client device(s) 110. In some embodiments, application 222 may run out of a Web browser, installed in client device(s) 110.

Dataset 227 may include multiple messages and multimedia files. A user of client device(s) 110 may store at least some of the messages or data content in dataset 227 in memory 220-1. In some embodiments, a user may upload, with client device(s) 110, dataset 225 onto server(s) 130. Database 152 may store data and files associated with application 222 (e.g., one or more of datasets 225 and 227).

Server(s) 130 may include application programming interface (API) layer 215, which may control application 222 in each of client device(s) 110. Server(s) 130 may also include memory 220-2 storing instructions which, when executed by processor 212-2, cause server(s) 130 to perform at least partially one or more steps or operations in processes or methods consistent with the present disclosure.

Processors 212-1 and 212-2 and memories 220-1 and 220-2 will be collectively referred to, hereinafter, as “processors 212” and “memories 220,” respectively.

Processors 212 may be configured to execute instructions stored in memories 220. In some embodiments, memory 220-2 may include recency scoring module 232, popularity scoring module 234, weighting module 236, or ranking module 238. Recency scoring module 232, popularity scoring module 234, weighting module 236, or ranking module 238 may share or provide features or resources to GUI 223, including any tools or modules associated with an application (e.g., application 222). A user may access recency scoring module 232, popularity scoring module 234, weighting module 236, or ranking module 238 through application 222, installed in memory 220-1 of client device(s) 110. Accordingly, application 222, including GUI 223, may be installed by server(s) 130 and perform scripts and other routines provided by server(s) 130 through any one of multiple tools. Execution of application 222 may be controlled by processor 212-1.

Recency scoring module 232 may be configured to calculate a recency score for a graphic element based on how recently the graphic element was used in a conversation thread. Recency scoring module 232 may take as input a timestamp for when a graphic element was posted, which may include a plurality of postings, and may provide as output a recency score. Recency may be determined by calculating a difference between a current time and the timestamp for when a graphic element was posted. In some embodiments, higher recency scores may be assigned to more recently posted graphic elements, and lower recency scores may be assigned to less recently posted graphic elements. Recency scoring module 232 may compute a recency score for a graphic element using a decay function, such as exponential decay, whereby graphic elements used more recently may receive higher recency scores. Recency scoring module 232 may normalize a recency score. In some embodiments, recency scoring module 232 may normalize a recency score using min-max normalization. Normalizing a recency score may ensure that graphic elements sent within a query period (e.g., the last 24 or 48 hours) or included in a query set (e.g., the last 20 or 50 graphic elements posted) are scored in a comparable way, regardless of the absolute time passed since the graphic elements were posted, and normalizing a recency score may allow for effective combination with a popularity score. Normalization may result in a range of [0,1]. For example, if a timestamp of a graphic element equals the current time, then the difference between the timestamp and the current time may be 0 and the normalized recency may be 1. If the difference between the timestamp and the current time is greater than or equal to the query period (e.g., 24 hours), then the normalized recency score may be 0.

Popularity scoring module 234 may be configured to calculate a popularity score for a graphic element based on how frequently the graphic element is posted in a conversation thread. Graphic elements that are posted more frequently may be considered more popular than graphic elements that are posted less frequently. Popularity scoring module 234 may take as input the number of times a graphic element was used in a conversation thread and may provide as output a popularity score. Frequency may be determined by counting how many times a graphic element has been posted in a conversation thread by a user or by other participants in the conversation thread. In some embodiments, higher popularity scores may be assigned to more frequently posted graphic elements, and lower popularity scores may be assigned to less frequently posted graphic elements. Popularity scoring module 234 may normalize a popularity score. In some embodiments, popularity scoring module 234 may normalize a popularity score using min-max normalization. Normalizing a popularity score may ensure that graphic elements sent within a query period (e.g., the last 24 or 48 hours) or included in a query set (e.g., the last 20 or 50 graphic elements posted) are scored in a comparable way to each other, and normalizing a popularity score may allow for effective combination with a recency score. Normalization may result in a range of [0,1]. For example, a frequency of a graphic element (that is, how many times a graphic element has been posted in a conversation thread) may be divided by a frequency of all the graphic elements (that is, how many times graphic elements have been posted in a conversation thread), resulting in a normalized popularity score. If a graphic element is used more frequently, then the popularity score would be close to the frequency of all the graphic elements, resulting in a normalized popularity score close to 1. If a graphic element is used less frequently (e.g., once or twice), then the popularity score would be a small value, and the normalized popularity score would be closer to 0.

Weighting module 236 may be configured to dynamically adjust the influence of recency scores and popularity scores in a final ranking of a graphic element. In some embodiments, weighting module 236 may leverage artificial intelligence (AI) techniques (e.g., machine learning (ML) algorithms) to determine a recency weight and a popularity weight. Weighting module 236 may modify a recency weight and a popularity weight based on different parameters, such as user preferences, conversation context, or real-time analysis of the conversation thread. By adjusting the weights, weighting module 236 may prioritize recency, resulting in the latest graphic elements being displayed more prominently, or may prioritize popularity, resulting in the more frequently posted graphic elements being displayed more prominently. Weighting module 236 may take as input a user context parameter, a time-of-day parameter, or a real-time feedback parameter, and weighting module 236 may provide as output a recency weight and a popularity weight. Using a user context parameter, contextual factors, such as the nature of a conversation or specific user behavior, may influence weight adjustment. For example, if a conversation is rapidly evolving, recency may be given a higher weight than popularity; if the conversation is calm or focused on specific graphic elements, then popularity may be given a higher weight than recency. Using a time-of-day parameter, the time of day may impact the recency weight or the popularity weight. For example, if a user tends to post in a conversation thread more at certain times, then weighting module 236 may adjust the weights to reflect that. Using a real-time feedback parameter, user actions and interactions (e.g., clicking on or reacting to certain graphic elements) may serve as real-time feedback to adjust weights. If users tend to engage more with graphic elements used earlier in the conversation thread, then the popularity weight may be increased. If users consistently respond to newer graphic elements, then the recency weight may be increased.

Ranking module 238 may be configured to rank and display graphic elements in a conversation thread of a messaging application. Ranking module 238 may calculate a rating score for a graphic element by combining a recency score, a recency weight, a popularity score, and a popularity weight. In some embodiments, the rating score may be calculated using a weighted sum formula. In some embodiments, once a rating score is calculated for a graphic element, the graphic element may be sorted (e.g., in descending order) with other graphic elements in a rating list. Graphic elements with higher rating scores may appear near the top of the rating list, and graphic elements with lower rating scores may appear near the bottom of the rating list. According to the rating list, a position of a graphic element in the display of graphic elements may be updated. If a graphic element is higher in the rating list, then the graphic element may be displayed more prominently in the input area of the conversation thread (e.g., higher in the input area, or nearer to a text input field of the input area). If a graphic element is lower in the rating list, then the graphic element may be displayed less prominently in the input area of the conversation thread (e.g., lower in the input area, or farther from a text input field of the input area).

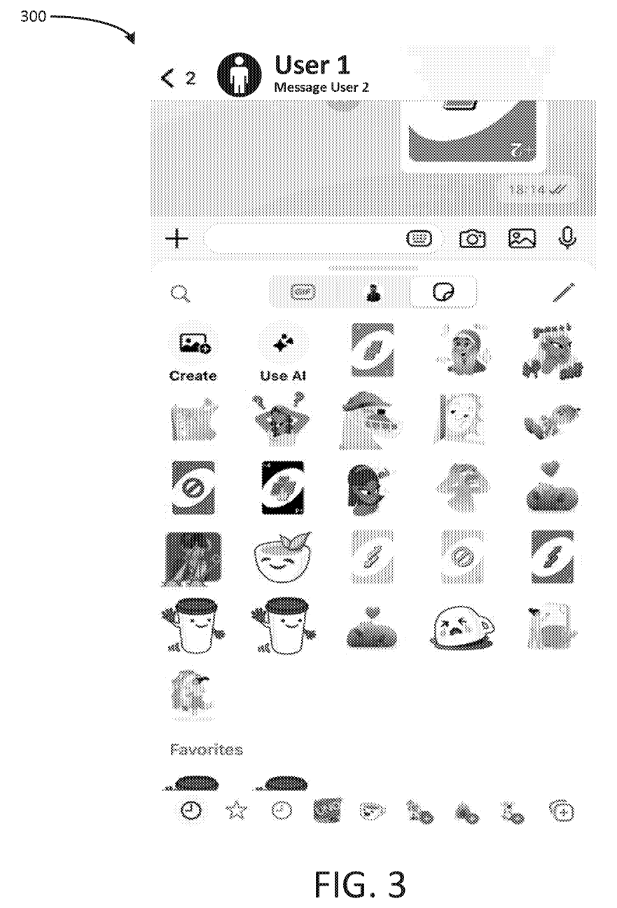

FIG. 3 includes an example view 300 of an input area of a user interface of a conversation thread of a messaging application, according to some embodiments.

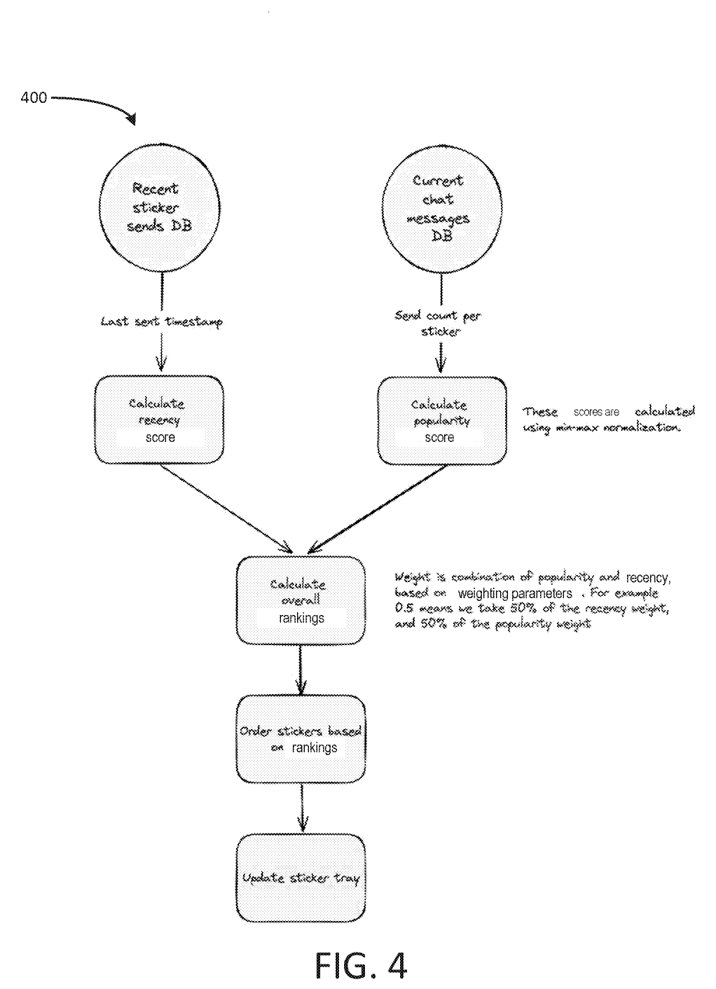

FIG. 4 includes an example process 400 for ranking graphic elements in a conversation thread of a messaging application, according to some embodiments.

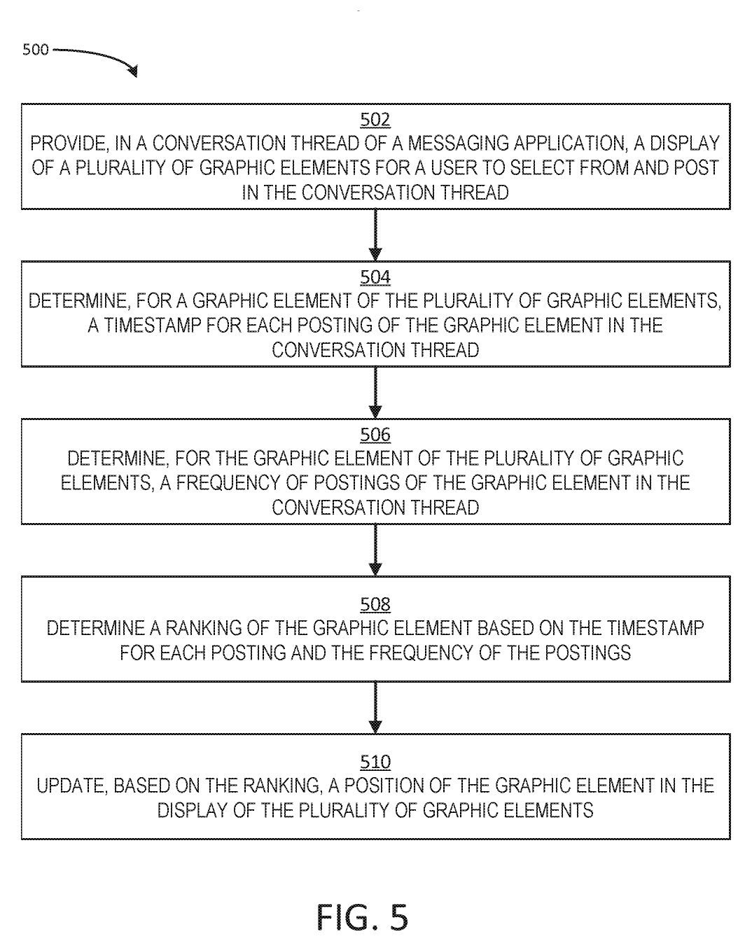

FIG. 5 is a flowchart illustrating operations in a method 500 for ranking graphic elements in a conversation thread, according to some embodiments. In some embodiments, processes as disclosed herein may be performed at least partially by a processor executing instructions stored in a memory, wherein the processor and the memory are part of a client device as disclosed herein (e.g., memories 220, processors 212, and client device(s) 110). In yet other embodiments, at least one or more of the operations in a process consistent with method 500 may be performed by a processor executing instructions stored in a memory wherein at least one of the processor and the memory are remotely located in a cloud server and a database, and the client device is communicatively coupled to the cloud server via a communications module coupled to a network (e.g., server(s) 130, database 152, communications modules 218, and network 150). In some embodiments, the server may include a recency scoring module, a popularity scoring module, a weighting module, and a ranking module (e.g., recency scoring module 232, popularity scoring module 234, weighting module 236, and ranking module 238). In some embodiments, processes consistent with the present disclosure may include at least one or more steps from method 500 performed in a different order, simultaneously, quasi-simultaneously, or overlapping in time.

Operation 502 may include providing, in a conversation thread of a messaging application, a display of a plurality of graphic elements for a user to select from and post in the conversation thread.

Operation 504 may include determining, for a first graphic element of the plurality of graphic elements, a timestamp for each posting of the first graphic element in the conversation thread. In some embodiments, determining the timestamp for each posting of the first graphic element may include determining the timestamp for each posting during a query period.

Operation 506 may include determining, for the first graphic element of the plurality of graphic elements, a frequency of postings of the first graphic element in the conversation thread. In some embodiments, determining the frequency of the postings of the first graphic element may include determining the frequency of the postings during a query period.

Operation 508 may include determining a first ranking of the first graphic element based on the timestamp for each posting and the frequency of the postings. In some embodiments, determining the first ranking of the first graphic element may include determining, based on the timestamp for each posting, a recency parameter, and determining, based on the frequency of the postings, a popularity parameter. In further aspects, determining the first ranking of the first graphic element may include determining, for the recency parameter, a recency weight, and determining, for the popularity parameter, a popularity weight. In further aspects, determining the first ranking of the first graphic element may include determining the first ranking of the first graphic element based on the recency parameter, the recency weight, the popularity parameter, and the popularity weight. In further aspects of the embodiments, operation 508 may include normalizing the recency parameter and the popularity parameter.

Operation 510 may include updating, based on the first ranking, a first position of the first graphic element in the display of the plurality of graphic elements. In some embodiments, updating the first position of the first graphic element in the display of the plurality of graphic elements may include determining the first ranking of the first graphic element is higher than a second ranking of a second graphic element of the plurality of graphic elements, and updating the position of the first graphic element in the display such that the first graphic element is more prominent than the second graphic element. In some embodiments, updating the first position of the first graphic element in the display of the plurality of graphic elements may include determining the first ranking of the first graphic element is lower than a second ranking of a second graphic element of the plurality of graphic elements, and updating the position of the first graphic element in the display such that the first graphic element is less prominent than the second graphic element.

### Hardware Overview

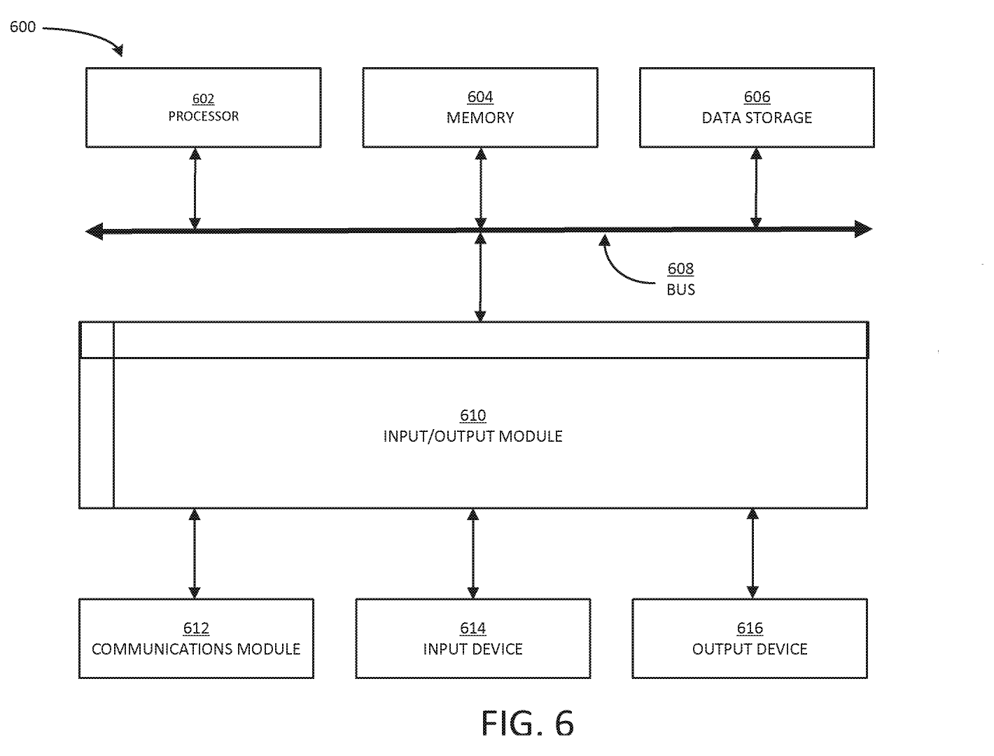

FIG. 6 is a block diagram illustrating an exemplary computer system 600 with which client devices, and the methods or processes of FIG. 5 may be implemented, according to some embodiments. In certain aspects, computer system 600 may be implemented using hardware or a combination of software and hardware, either in a dedicated server, or integrated into another entity, or distributed across multiple entities.

Computer system 600 (e.g., client device(s) 110 and server(s) 130) may include bus 608 or another communication mechanism for communicating information, and processor 602 (e.g., processors 212) coupled with bus 608 for processing information. By way of example, computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 600 may include, in addition to hardware, code that creates an execution environment for the computer program in question, e.g., code that constitutes processor firmware, a protocol stack, a database management system, an operating system, or a combination of one or more of them stored in an included memory 604 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. Processor 602 and the memory 604 may be supplemented by, or incorporated in, special purpose logic circuitry.

The instructions may be stored in memory 604 and implemented in one or more computer program products, e.g., one or more modules of computer program instructions encoded on a computer-readable medium for execution by, or to control the operation of, computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one computer or on multiple computers that may be located at one site or distributed across multiple sites and interconnected by a communication network. The processes and logic flows described in this specification may be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. Input/output module 610 may be any input/output module. Exemplary input/output modules 610 include data ports such as Universal Serial Bus (USB) ports. The input/output module 610 may be configured to connect to a communications module 612. Exemplary communications modules 612 (e.g., communications modules 218) include networking interface cards, such as Ethernet cards and modems. In certain aspects, input/output module 610 may be configured to connect to a plurality of devices, such as an input device 614 (e.g., input device 214) and/or an output device 616 (e.g., output device 216). Exemplary input devices 614 include a keyboard and a pointing device, e.g., a mouse or a trackball, by which a user may provide input to computer system 600. Other kinds of input devices 614 may be used to provide for interaction with a user as well, such as a tactile input device, visual input device, audio input device, or brain-computer interface device. For example, feedback provided to the user may be any form of sensory feedback, e.g., visual feedback, auditory feedback, or tactile feedback; and input from the user may be received in any form, including acoustic, speech, tactile, or brain wave input. Exemplary output devices 616 include display devices, such as an LCD (liquid crystal display) monitor, for displaying information to the user.

According to one aspect of the present disclosure, client device(s) 110 and server(s) 130 may be implemented using computer system 600 in response to processor 602 executing one or more sequences of one or more instructions contained in memory 604. Such instructions may be read into memory 604 from another machine-readable medium, such as data storage device 606. Execution of the sequences of instructions contained in memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, e.g., a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. The communication network (e.g., network 150) may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules may be, for example, modems or Ethernet cards.

Computer system 600 may include clients and servers. A client and server may be generally remote from each other and typically interact through a communication network. The relationship of client and server arises by virtue of computer programs running on the respective computers and having a client-server relationship to each other. Computer system 600 may be, for example, and without limitation, a desktop computer, laptop computer, or tablet computer. Computer system 600 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires forming bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer may read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method clauses may be provided to present elements of the various steps, operations, or processes in a sample order, and are not meant to be limited to the specific order or hierarchy presented.

Although illustrative embodiments have been shown and described, a wide range of modification, change, and substitution are contemplated in the foregoing disclosure and in some instances, some features of the embodiments may be employed without a corresponding use of other features. Those of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A computer-implemented method, comprising:
providing, in a conversation thread of a messaging application, a display of a plurality of graphic elements for a user to select from and post in the conversation thread;
determining, for a first graphic element of the plurality of graphic elements, a timestamp for each posting of the first graphic element in the conversation thread;
determining, for the first graphic element of the plurality of graphic elements, a frequency of postings of the first graphic element in the conversation thread;
determining a first ranking of the first graphic element based on the timestamp for each posting and the frequency of the postings; and
updating, based on the first ranking, a first position of the first graphic element in the display of the plurality of graphic elements.

2. The computer-implemented method of claim 1, wherein determining the first ranking of the first graphic element includes:
determining, based on the timestamp for each posting, a recency parameter;
determining, based on the frequency of the postings, a popularity parameter;
determining, for the recency parameter, a recency weight;
determining, for the popularity parameter, a popularity weight; and
determining the first ranking of the first graphic element based on the recency parameter, the recency weight, the popularity parameter, and the popularity weight.

3. The computer-implemented method of claim 2, further comprising:
normalizing the recency parameter and the popularity parameter.

4. The computer-implemented method of claim 1, wherein:
determining the timestamp for each posting of the first graphic element includes determining the timestamp for each posting during a query period; and
determining the frequency of the postings of the first graphic element includes determining the frequency of the postings during the query period.

5. The computer-implemented method of claim 1, wherein updating the first position of the first graphic element in the display of the plurality of graphic elements includes:
determining the first ranking of the first graphic element is higher than a second ranking of a second graphic element of the plurality of graphic elements; and
updating the position of the first graphic element in the display such that the first graphic element is more prominent than the second graphic element.

6. The computer-implemented method of claim 1, wherein updating the first position of the first graphic element in the display of the plurality of graphic elements includes:
determining the first ranking of the first graphic element is lower than a second ranking of a second graphic element of the plurality of graphic elements; and
updating the position of the first graphic element in the display such that the first graphic element is less prominent than the second graphic element.

7. A system, comprising:
one or more processors; and
a memory storing instructions which, when executed by the one or more processors, cause the system to perform operations, including:
providing, in a conversation thread of a messaging application, a display of a plurality of graphic elements for a user to select from and post in the conversation thread;
determining, for a first graphic element of the plurality of graphic elements, a timestamp for each posting of the first graphic element in the conversation thread;
determining, for the first graphic element of the plurality of graphic elements, a frequency of postings of the first graphic element in the conversation thread;
determining a first ranking of the first graphic element based on the timestamp for each posting and the frequency of the postings; and
updating, based on the first ranking, a first position of the first graphic element in the display of the plurality of graphic elements.

8. The system of claim 7, wherein determining the first ranking of the first graphic element includes:
determining, based on the timestamp for each posting, a recency parameter;
determining, based on the frequency of the postings, a popularity parameter;
determining, for the recency parameter, a recency weight;
determining, for the popularity parameter, a popularity weight; and
determining the first ranking of the first graphic element based on the recency parameter, the recency weight, the popularity parameter, and the popularity weight.

9. The system of claim 8, wherein the operations further comprise:
normalizing the recency parameter and the popularity parameter.

10. The system of claim 7, wherein:
determining the timestamp for each posting of the first graphic element includes determining the timestamp for each posting during a query period; and
determining the frequency of the postings of the first graphic element includes determining the frequency of the postings during the query period.

11. The system of claim 7, wherein updating the first position of the first graphic element in the display of the plurality of graphic elements includes:
determining the first ranking of the first graphic element is higher than a second ranking of a second graphic element of the plurality of graphic elements; and
updating the position of the first graphic element in the display such that the first graphic element is more prominent than the second graphic element.

12. The system of claim 7, wherein updating the first position of the first graphic element in the display of the plurality of graphic elements includes:
determining the first ranking of the first graphic element is lower than a second ranking of a second graphic element of the plurality of graphic elements; and
updating the position of the first graphic element in the display such that the first graphic element is less prominent than the second graphic element.

13. A non-transitory computer-readable storage medium having instructions embodied thereon, the instructions embodied thereon being executable by one or more processors to perform operations, the operations comprising:
providing, in a conversation thread of a messaging application, a display of a plurality of graphic elements for a user to select from and post in the conversation thread;
determining, for a first graphic element of the plurality of graphic elements, a timestamp for each posting of the first graphic element in the conversation thread;
determining, for the first graphic element of the plurality of graphic elements, a frequency of postings of the first graphic element in the conversation thread;
determining a first ranking of the first graphic element based on the timestamp for each posting and the frequency of the postings; and
updating, based on the first ranking, a first position of the first graphic element in the display of the plurality of graphic elements.

14. The non-transitory computer-readable storage medium of claim 13, wherein determining the first ranking of the first graphic element includes:
determining, based on the timestamp for each posting, a recency parameter;
determining, based on the frequency of the postings, a popularity parameter;
determining, for the recency parameter, a recency weight;
determining, for the popularity parameter, a popularity weight; and
determining the first ranking of the first graphic element based on the recency parameter, the recency weight, the popularity parameter, and the popularity weight.

15. The non-transitory computer-readable storage medium of claim 14, wherein the operations further comprise:
normalizing the recency parameter and the popularity parameter.

16. The non-transitory computer-readable storage medium of claim 13, wherein:
determining the timestamp for each posting of the first graphic element includes determining the timestamp for each posting during a query period; and
determining the frequency of the postings of the first graphic element includes determining the frequency of the postings during the query period.

17. The non-transitory computer-readable storage medium of claim 13, wherein updating the first position of the first graphic element in the display of the plurality of graphic elements includes:
determining the first ranking of the first graphic element is higher than a second ranking of a second graphic element of the plurality of graphic elements; and
updating the position of the first graphic element in the display such that the first graphic element is more prominent than the second graphic element.

18. The non-transitory computer-readable storage medium of claim 13, wherein updating the first position of the first graphic element in the display of the plurality of graphic elements includes:
determining the first ranking of the first graphic element is lower than a second ranking of a second graphic element of the plurality of graphic elements; and
updating the position of the first graphic element in the display such that the first graphic element is less prominent than the second graphic element.
